(19) United States
(12) Patent Application Publication
(10) Pub. No.: US 2024/0214199 A1
(43) Pub. Date: Jun. 27, 2024

(54) METHOD FOR SECURE EXCHANGES BETWEEN AN ACCESS CONTROL READER, IOT HUB AND A DATA PROCESSING UNIT

(71) Applicant: SYSTEMES ET TECHNOLOGIES IDENTIFICATION (STID), GREASQUE (FR)

(72) Inventors: Vincent DUPART, SAINT-MAXIMIN-LA-SAINTE-BEAUME (FR); Sylvain POITRAT, GREASQUE (FR); Eric MUGNIER, LES PENNES-MIRABEAU (FR)

(21) Appl. No.: 18/277,277

(22) PCT Filed: Feb. 17, 2022
(86) PCT No.: PCT/FR2022/050285

§ 371 Date: Mar. 1, 2024

(30) Foreign Application Priority Data
Feb. 24, 2021 (FR) 21/01784

(51) Int. Cl. H04L 9/30; H04L 9/32

(52) U.S. Cl. CPC H04L 9/30; H04L 9/3263

(57) ABSTRACT

Method (100) for secure communication between a reader (B) and a controller (A) that are configured to communicate with one another, the method comprising the following phases, implemented by the reader (B): a phase (101) of the reader (B) reading apiece of information; a phase (102) of exchanging a public key (B_{SpubK}) of the reader (B) and a public key (A_{SpubK}) of the controller (A); a phase (103) of generating a string of session keys; a phase (104) of confirming the string of keys based on the use of a first session key (k₀) of the string of session keys, a protocol phase (105) of secure communication between the reader (B) and the controller (A).

### TECHNICAL FIELD

The present disclosure concerns the field of the cryptography and of the protocols for securing digital communications.

### BACKGROUND

It is known to secure the digital communications between a server and a client. The existing server/client type security protocols require a significant computing power, which is not available on an access control reader or on a connected object hub, which we will also refer to as an IOT (Internet of Things) hub, and on the corresponding data processing unit, when said access control reader/IOT hub is intended to control the access to a given area, by reading the identification data of a user on a, RFID technology for example, badge and by transmitting the read data to the data processing unit for control by the data processing unit. The use of known protocols such as for example the TLS protocol for the server/client systems to authenticate the data processing unit and the access control reader/IOT hub, and to ensure the security of the information exchanges between the data processing unit and the access control reader/LOT hub with a satisfactory level of security requires a computing power which the data processing unit and the access control reader of an access control device/IOT hub do not necessarily have.

Moreover, in a server/client authentication system, each key exchange and authentication protocol must be carried out for each of the clients connected to the server because these are of different natures and from different manufacturers whereas in the case of access control systems/IOT hub, the readers and IOT apparatuses are generally of the same nature for a given installation site. In this specific case, it therefore becomes superfluous and time-consuming to manage for each of the readers/IOT a different key negotiation and authentication protocol.

In order to guarantee a security throughout the life of the installation, it is known to update the session keys once the authentication has been performed to guard against brute force attacks. However, this type of processing requires sending new authentication keys with a complex protocol which will further add processing complexity in the readers/IOT.

There is a risk of spying on the links between access control systems/IOT hubs, the readers and IOT apparatuses, in order to manage “man-in-the-middle” type attacks allowing an attacker to insert themselves into the existing link by impersonating a fake controller or a fake reader. This type of attack could be avoided by a 2-step exchange architecture.

The authentication protocols mentioned above such as TLS may use the certificate exchange to exchange their public keys. The structure of the current certificates does not allow to include the serial number of the reader/IOT because in general the certificates are global for the different servers in a server/client architecture.

Finally, the access control readers/IOT and their controllers will evolve over time to become more and more powerful, which would eventually make it possible to use the existing TLS type authentication protocols and then include the method for secure exchanges between a reader and a controller configured to communicate with each other in the data packets of the IP type frames. In the latter case, it would be very complex to redo the exchange layer between the controllers and access control readers/IOT and it is therefore necessary to be able to optimize this integration.

### BRIEF SUMMARY

The disclosure proposes a solution to all or part of these problems.

To this end, the present disclosure concerns a method for secure exchanges between a reader and a controller configured to communicate with each other via a communication channel, the method comprising the following phases implemented by the reader:
a phase of reading at least one information by the reader;
a phase of exchanging a public key of the reader and a public key of the controller;
a phase of generating a sequence of session keys;
a phase of confirming the sequence of session keys based on the use of a first session key of the sequence of session keys,
a protocol phase for secure communication between the reader and the controller.

According to one implementation, the disclosure comprises one or more of the following characteristics, alone or in a technically acceptable combination.

According to one implementation, the reader and the controller are configured to provide a control of access to a protected area.

According to one implementation, the reader is an access control reader, for example a RFID badge reader, or an IOT hub, configured to read the digital information contained in the badge.

In the rest of the text, the access control reader will designate both the badge reader for the control of access to a given area and the IOT hub.

According to one implementation, the phase of exchanging a public key of the controller comprises exchanging a plurality of public keys of the controller.

According to one implementation, the key exchange phase comprises:
a step of receiving the public key of the controller, and receiving a list of security mechanisms proposed by the controller, and receiving a security parameter generated by the controller;
a step of emitting to the controller, the public key of the reader, and a serial number of the reader, and a security mechanism accepted by the reader, said security mechanism being chosen from among the list of security mechanisms, and a security parameter generated by the reader; According to one implementation, the serial number of the reader is transformed or encrypted.

According to one implementation, the key exchange phase is carried out during a phase of configuring the reader before a phase for on-site installation of the reader, via another communication channel between the reader and the controller, said other communication channel being different from the communication channel.

According to one implementation, the other communication means is a wide area network, such as the Internet, or a radio link.

According to these provisions, a spying on the exchanges during the key exchange phase is avoided.

According to one implementation, the information received, respectively emitted, during the key exchange phase is encapsulated in an IP frame According to one implementation, the public key of the controller is received in a certificate of the controller.

According to one implementation, the public key of the reader is emitted in a certificate of the reader.

According to one implementation, the certificate of the reader contains the serial number of the reader.

According to one implementation, the public key of the controller is received in a certificate of the controller, and the public key of the reader is emitted in a certificate of the reader.

According to one implementation, the serial number of the reader is encrypted or transformed.

According to these provisions, the choice of the security mechanism from the list of security mechanisms makes it possible to adjust the need for computing power to the resources available on the reader and on the controller.

According to one implementation, the controller is configured to communicate with several readers comprising a master reader and other readers, the security mechanism being accepted by the master reader during a phase of exchange of keys between the controller and the master reader, the security mechanism accepted by the master reader then being the only one proposed to the other readers during another phase of exchange of keys with each of the other readers.

According to these provisions, the security between all readers is homogenized.

According to one implementation, the step of receiving the public key of the controller comprises receiving a plurality of public keys of the controller.

According to one implementation, the security parameter generated by the controller is generated randomly, for example according to a cryptographic method.

According to one implementation, the security parameter generated by the reader is generated randomly, for example according to a cryptographic method.

According to one implementation, the phase of generating a sequence of session keys comprises the following steps:
a step of calculating a secret, shared by the reader and by the controller, the secret being calculated from a private key of the reader and from the public key of the controller;
a step of calculating the sequence of session keys from the shared secret, and from the serial number of the reader, and from the security parameter generated by the reader, and from the security parameter generated by the controller;

According to one implementation, the calculation of the shared secret uses the Diffie-Hellman type key exchange based on elliptic curves.

According to one implementation, the calculation of the shared secret uses the Diffie-Hellman key exchange based on public key algorithms.

According to one implementation, the step of calculating the sequence of session keys from the shared secret may be triggered by a fulfillment of a triggering condition among the following triggering conditions:
an idle time of the controller greater than a predetermined threshold;
a number of events greater than a predetermined threshold, the number of events being counted by a counter common to the reader and to the controller;
a command of the controller.

According to these provisions, it is possible to generate new session keys without needing to restart the phase of exchange of keys between the controller and the reader with a new shared secret calculation. An idle time of the controller greater than a predetermined threshold may mean that the reader has changed its session keys.

According to one implementation, the confirmation phase of the sequence of keys comprises:
a step of receiving a first authentication code calculated by the controller according to the first session key of the sequence of session keys, and according to an identifier of the controller, and an identifier of the reader, and the security parameter generated by the reader, and the security parameter generated by the controller;
a step of emitting a second authentication code calculated by the reader according to the first session key of the sequence of session keys, and according to the identifier of the controller, and the identifier of the reader, and the security parameter generated by the reader, and the security parameter generated by the controller;
a step of verifying the first authentication code received;

According to one implementation, the first authentication code is calculated according to a first predetermined alphanumeric value.

According to one implementation, the second authentication code is calculated according to a second predetermined alphanumeric value.

According to one implementation, the security parameter generated by the reader is another public key generated by the reader, to which another private key generated by the reader corresponds, and in which the secret is concatenated with another shared secret calculated from the other private key generated by the reader and from the public key of the controller, and the concatenated shared secret becoming the shared secret used for the step of calculating the sequence of session keys.

According to one implementation, the security parameter generated by the controller is another public key generated by the controller, to which another private key generated by the controller corresponds, and in which the other shared secret is calculated from the other private key generated by the reader and from the public key of the controller.

According to one implementation, the protocol phase comprises a step of receiving by the reader a secure request coming from the controller, a step of calculating a signature from the read information and from a key of a sequence of session keys and a step of creating a frame comprising the signature concatenated with the read information and with an anti-replay counter, and a step of encrypting the frame by using another key of the sequence of session keys, and a step of transmitting the encrypted frame.

According to these provisions, after the first authentication phases, the communication between the reader and the reader is secure.

The disclosure also concerns a method for secure communication between a reader and a controller, the method comprising the following phases implemented by the controller:
a phase of exchanging a public key of the reader and a public key of the controller;
a phase of generating a sequence of session keys;
a phase of confirming the sequence of keys based on the use of a first session key of the sequence of session keys.
a protocol phase for secure communication between the reader and the controller.

According to one implementation, the controller is configured to control the identity, and the access to a given area, of a user of the badge from the information read by the reader on the badge and received by the controller, the method comprising a final phase of controlling an identity of a user of the badge.

According to one implementation, the phase of exchanging a public key of the reader and a public key of the controller, comprises:
a step of emitting to the reader, the public key of the controller and a list of security mechanisms proposed by the controller, and a security parameter generated by the controller;
a step of receiving the public key of the reader, and a serial number of the reader, and a security mechanism accepted by the reader, said security mechanism being chosen from among the list, and a security parameter generated by the reader.

According to one implementation, the serial number of the reader is transformed or encrypted.

According to one implementation, the key exchange phase is carried out before a phase for on-site installation of the reader, via another means of communication between the reader and the controller, the other communication means being different from the communication means used on-site.

According to one implementation, the other communication means is an extended network, such as the Internet, or a radio link.

According to these provisions, a spying on the exchanges during the key exchange phase is avoided.

According to one implementation, the information received, respectively emitted during the key exchange phase are encapsulated in an IP frame.

According to one implementation, the public key of the controller is received with a certificate of the controller.

According to one implementation, the public key of the reader is emitted with a certificate of the reader.

According to one implementation, the certificate of the reader contains the serial number of the reader.

According to one implementation, the serial number of the reader is encrypted or transformed.

According to one implementation, the controller is configured to communicate with several readers comprising a master reader and other readers, the security mechanism being accepted by the master reader during a phase of exchange of keys between the controller and the master reader, the security mechanism accepted by the master reader then being the only one proposed to the other readers during another phase of exchange of keys with each of the other readers.

According to these provisions, the security between all the readers is homogenized.

According to one implementation, the step of emitting the public key of the controller comprises emitting a plurality of public keys of the controller.

According to one implementation, the phase of generating a sequence of session keys comprises the following steps:
a step of calculating a secret, shared by the reader and by the controller, the secret being calculated from a private key of the controller and from the public key of the reader;
a step of calculating the sequence of session keys from the shared secret, and from the serial number of the reader, and from the security parameter generated by the reader, and from the security parameter generated by the controller;

According to one implementation, the calculation of the shared secret uses the Diffie-Hellman key exchange based on elliptic curves.

According to one implementation, the calculation of the shared secret uses the Diffie-Hellman key exchange based on public key algorithms.

According to one implementation, the step of calculating the sequence of session keys from the shared secret may be triggered by a fulfillment of a triggering condition among the following triggering conditions:
an idle time of the controller greater than a predetermined threshold;
a number of events greater than a predetermined threshold, the number of events being counted by a counter common to the reader and to the controller;
a command of the controller.

According to these provisions, it is possible to generate new session keys without needing to restart the phase of exchange of keys between the controller and the reader with a new shared secret calculation. An idle time of the controller greater than a predetermined threshold may mean that the reader has changed its session keys.

According to one implementation, the phase of confirming the sequence of keys comprises:
a step of emitting a first authentication code calculated by the controller according to the first session key of the sequence of session keys, and according to an identifier of the controller, and an identifier of the reader, and the security parameter generated by the reader, and the security parameter generated by the controller;
a step of receiving a second authentication code calculated by the reader according to the first session key of the sequence of session keys, and according to an identifier of the controller, and an identifier of the reader, and the security parameter generated by the reader, and the security parameter generated by the controller;
a step of verifying the second authentication code received.

According to one implementation, the first authentication code is calculated according to a first predetermined alphanumeric value.

According to one implementation, the second authentication code is calculated according to a second predetermined alphanumeric value.

According to one implementation, the security parameter generated by the reader is another public key generated by the reader, and in which the shared secret is concatenated with another shared secret calculated from the private key of the controller and from the other public key generated by the reader, the concatenated shared secret becoming the shared secret used for the step of calculating the sequence of session keys.

According to one implementation, the security parameter generated by the controller is another public key generated by the controller, to which another private key generated by the controller corresponds, and in which the other shared secret is calculated from the other private key generated by the controller and from the other public key generated by the reader.

According to one implementation, the protocol phase comprises a step of emitting by the controller to the reader a secure request, a step of receiving an encrypted frame, a step of decrypting the frame by using a key of the sequence of session keys, the decrypted frame comprising a signature concatenated with the read information and with an anti-replay counter, and a step of verifying the signature with another key of the sequence of session keys and the anti-replay counter.

According to one implementation, the controller is configured to communicate with a plurality of readers, a reader among the plurality of readers being a master reader, the security mechanism being accepted by the master reader during a phase of exchange of keys between the controller and the master reader, the security mechanism accepted by the master reader then being the only one proposed to the other readers of the plurality of readers, during another phase of exchange of keys between the controller with each of the other readers of the plurality of readers.

According to one implementation, the plurality of readers comprises a first group of readers configured to protect the access to a first area, and in which the plurality of readers comprises at least one second group of readers configured to protect the access to at least one second area, and in which the master reader belongs to the first group of readers, the security mechanism being accepted by the master reader during a phase of exchange of keys between the controller and the master reader, the security mechanism accepted by the master reader then being the only one proposed to the other readers of the first group of readers during another phase of exchange of keys between the controller with each of the other readers of the first group of readers.

According to one aspect of the disclosure, the disclosure also concerns an access control reader for controlling access to an area, configured to communicate information, read on a badge, to a controller, according to one of the examples of implementation of the method described above.

According to another aspect of the disclosure, the disclosure also concerns a controller of an access control reader configured to communicate with the access control reader according to one of the examples of implementation of the method 200 described above.

### BRIEF DESCRIPTION OF THE DRAWINGS

For its good understanding, an embodiment and/or implementation of the disclosure is described with reference to the attached drawings representing, by way of non-limiting example, an embodiment or implementation respectively of a device and/or method according to the disclosure. The same references in the drawings designate similar elements or elements whose functions are similar.

FIG. 1 is a schematic representation of the steps of the method according to the disclosure, from the point of view of the controller on the one hand, and from the point of view of an access control reader on the other hand.

FIG. 2 is a schematic representation of an installation comprising a controller and several readers.

FIG. 3 is a schematic representation of another installation comprising a controller and several readers, with a master reader for the whole installation.

FIG. 4 is a schematic representation of another installation comprising a controller and several readers, organized into two distinct groups of readers, and a master reader for a single group of readers.

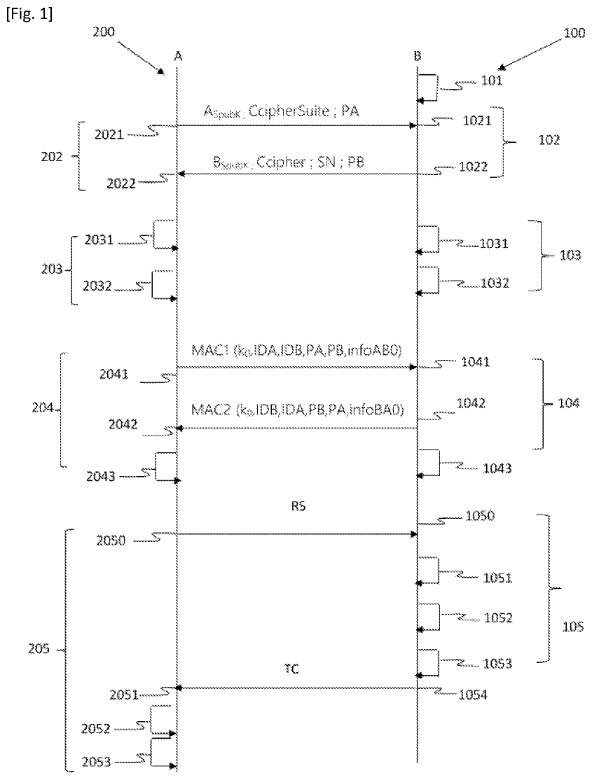

### DETAILED DESCRIPTION

The secure exchange protocol or method 100, 200 according to the disclosure is intended to a device for controlling access to a protected area or to an IOT hub. The access control device typically comprises a badge reader B and a logic processing unit (UTL), also called controller A. The access control reader B implements, for example, the RFId type technology configured for reading the information contained in a RFId type badge; the access control reader B is configured to implement embedded firmware, and to communicate with the controller A, for example via a serial link of the RS485 type, according to a secure communication method 100, 200 according to the disclosure. The secure communication method 100, 200 according to the disclosure comprises a part of the secure communication method 100 implemented more particularly by the access control reader B and another part of the secure communication method 200 implemented more particularly by the controller A. This method makes it possible to first perform an authentication between the controller A and the reader B, and secondly to ensure the security of the communications between the reader B and the controller A.

To adapt to the limited computing power of the reader B and of the controller A of the access control device, the secure communication method 100 implemented more particularly by the access control reader B comprises the following phases:
a phase 101 of reading information by the reader B;
a phase 102 of exchanging a public key B_{SpubK} of the reader B, and one or more public key(s) A_{SpubK} of the controller A;
a phase 103 of generating a sequence of session keys;
a phase 104 of confirming the sequence of keys based on the use of a first session key k₀ of the sequence of session keys,
a protocol phase 105 for secure communication between the reader B and the controller A.

Symmetrically, and in correspondence with the phases of the method 100 implemented by the reader B, the secure communication method 200 implemented more particularly by the controller A, comprises the following phases:
a phase 202 of exchanging a public key B_{SpubK} of the reader B and a public key A_{SpubK} of the controller A;
a phase 203 of generating a sequence of session keys;
a phase 204 of confirming the sequence of keys based on the use of a first session key k₀ of the sequence of session keys.
a protocol phase 205 for secure communication between the reader B and the controller A.

According to these provisions, after the first phases 102, 202, 103, 203, 104, 204, of the method 100, 200, which are phases of authentication and confirmation of the keys of the sequence of keys, the communication between the reader B and the reader A during the protocol phase 105, 205 is secure. The first session key k0 of the sequence of session keys is a first session key chosen among the keys of the sequence of session keys, but is not necessarily the first of the sequence of keys.

According to one example, the protocol phase 105 of the method 100 implemented by the reader B, comprises a step 1050 of receiving by the reader B a secure request RS coming from the controller A, a step of calculating a signature 1051 from the read information and from a key of the sequence of session keys and a step 105 of creating a frame comprising the signature concatenated with the read information and with an anti-replay counter, and a step 1053 of encrypting the frame by using another key of the sequence of session keys, and a step 1054 of transmitting the encrypted frame TC.

Correspondingly, the protocol phase 205 of the method 200 implemented by the controller A, comprises a step 2050 of emitting by the controller A to the reader B a secure request RS, a step 2051 of receiving an encrypted frame TC, a step 2052 of decrypting the frame by using a key of the sequence of session keys, the decrypted frame comprising a signature concatenated with the read information and with an anti-replay counter, and a step 2053 of verifying the signature with another key of the sequence of session keys and the anti-replay counter.

In particular, to adapt to the limited computing power of the reader B and of the controller A of the access control device, the key exchange phase 102 of the authentication phases of the method 100 implemented by the reader B comprises:
a step 1021 of receiving the public key(s) A_{SpubK} of the controller A, and of receiving a list of security mechanisms CcipherSuite proposed by the controller A, and of receiving a security parameter PA generated by the controller A;
a step 1022 of emitting to the controller A, the public key B_{SpubK} of the reader B, and a serial number SN of the reader B, or a representation of a serial number SN transformed of the reader B, or encrypted by one of the public key(s) A_{SpubK} of the controller A, and a security mechanism Ccipher accepted by the reader B, said security mechanism Ccipher being chosen from among the list of security mechanisms CcipherSuite, and a security parameter PB generated by the reader B. The transformation of the serial number may consist for example of a translation, or an inversion, or a mixture with another number. The encryption of the serial number may for example be carried out with the public key of the controller received in the previous step.

According to these provisions, the choice of the security mechanism from the list of security mechanisms makes it possible to adjust the need for computing power to the resources available on the reader and on the controller.

More particularly, the step of receiving the public key of the controller comprises receiving a plurality of public keys of the controller.

For example, the security parameter generated by the controller and/or the reader is generated randomly, according to a cryptographic method.

Symmetrically, and in correspondence with the steps of the key exchange phase 102 of the method 100 implemented by the reader B, the phase 202 of exchanging a public key B_{SpubK} of the reader B and a public key A_{SpubK} of the controller A, comprises:
a step 2021 of emitting to the reader B, the public key(s) A_{SpubK} of the controller A, and a list of security mechanisms CcipherSuite proposed by the controller A, and a security parameter PA generated by the controller A;
a step 2022 of receiving the public key B_{SpubK} of the reader B, and a serial number SN of the reader B, and a security mechanism Ccipher accepted by the reader B, said security mechanism Ccipher being chosen from among the list CcipherSuite, and a security parameter PB generated by the reader B.

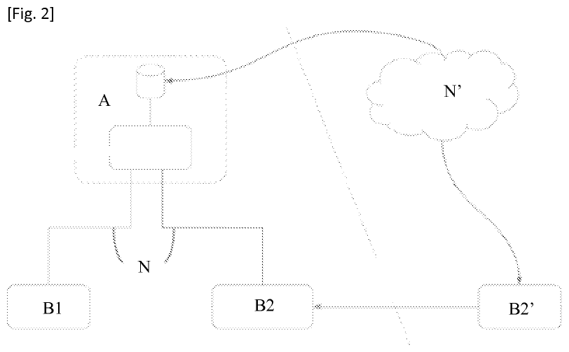

In particular, considering the installation, illustrated in FIG. 2, which comprises a controller A and several readers B1, B2, the key exchange phase may be carried out during a phase of configuring the reader B2, before a phase for on-site installation of the configured reader B2, via another communication channel N′; said other communication channel N′ allowing the reader B2 in the configuration phase, designated in FIG. 2 by the reference B2′ to distinguish it from the reader B2 configured and installed on the operative site, to communicate with.

More particularly, the other communication means N′ is an extended network, such as the Internet, or a radio link.

Thus, a spying is avoided on the communication channel N, used on the operative site for the exchanges during the key exchange phase on the operative site, since this key exchange has already been carried out via the other communication channel N.

According to one example of implementation, the information received, respectively emitted during the key exchange phase are encapsulated in an IP frame In particular, the public key of the controller is received with a certificate of the controller, and the public key of the reader is emitted in a certificate of the reader.

More particularly, the certificate of the reader contains the serial number of the reader, in clear, encrypted or transformed.

In particular again, the phase 103 of generating a sequence of session keys of the method 100 implemented by the reader B comprises:
a step 1031 of calculating a secret S, shared by the reader B and by the controller A, the secret S being calculated from a private key B_{SprivK} of the reader B and from the public key A_{SpubK} of the controller A; for example, for an elliptic curve-based algorithm, the shared secret S=S_{S}|S_{E}, where:

$${S}_{S} = ECDH ( {A}_{S p r i v K} , {B}_{SpubK} )$$

$${S}_{E} = ECDH ( {A}_{E p r i v K} , {B}_{EpubK} ) ,$$

where B_{EpubK} is another public key generated by the reader B, to which another private key B_{EprivK} generated by the reader B corresponds, and where A_{EprivK} is another private key generated by the controller A, to which another public key A_{EpubK} generated by the controller A corresponds;
a step 1032 of calculating the sequence of session keys Ki from the shared secret S, and from the serial number SN of the reader B, and from the security parameter PB generated by the reader B, and from the security parameter PA generated by the controller A.

For example: P

$$Ki = KDFi ( SNR , S , PA , PB ) with i = [ 0 : 3 ] ;$$

where KDFi designates an algorithm making it possible to calculate several session keys Ki; for example KDF is one of the algorithms known to those skilled in the art, such as for example the algorithms defined in Wikipedia/Key derivation function; the algorithm KDF is for example executed 4 times in order to obtain 4 session keys Ki, i=1 to 3.

According to one implementation, this step 1032 of calculating the sequence of session keys from the shared secret S may be restarted either on:
a temporal event: Based on an idle time of the controller A. If the controller A has not exchanged with the reader for a period of time then the controller A assumes that the reader has changed its session keys;
a counter: change triggering on a counter common between the controller and the readers;
a command of the controller: request of the controller A to renew the session keys on its initiative. It would also be possible in this case to ask to restart a protocol negotiation;

This principle therefore makes it possible to generate new session keys different from the previous keys without needing to restart the protocol of exchange key and/or of exchanges between the controller and the reader allowing a new calculation of session keys.

Symmetrically, and in correspondence with the steps of phase 103 of generating a sequence of session keys of the method 100 implemented by the reader B, the phase 203 of generating a sequence of session keys of the method 200 implemented by the controller A, comprises the following steps:
a step 2031 of calculating a secret S, shared by the reader B and by the controller A, the secret S being calculated from a private key A_{SprivK} of the controller A and from the public key B_{SpubK} of the reader B;
a step 2032 of calculating the sequence of session keys from the shared secret S, and from the serial number SN of the reader B, and from the security parameter PB generated by the reader B, and from the security parameter PA generated by the controller A.

Symmetrically, and in correspondence with the steps of the phase 103 of generating a sequence of session keys of the method 100 implemented by the reader B, the calculation of the sequence of session keys from the shared secret S may be restarted by the controller either with the use of a time counter, unit counter or on its initiative by sending a command of renewing session keys

More particularly, the calculation of the shared secret uses the Diffie-Hellman key exchange based on elliptic curves.

More particularly, the calculation of the shared secret uses the Diffie-Hellman key exchange based on public key algorithms.

In particular, the phase 104 of confirming the sequence of keys of the method 100 implemented by the reader B comprises:
a step 1041 of receiving a first authentication code MAC1 calculated by the controller A according to the first session key k₀ of the sequence of session keys, and according to an identifier IDA of the controller A, and an identifier IDB of the reader B, and the security parameter PB generated by the reader B, and the security parameter PA generated by the controller A;
a step 1042 of emitting a second authentication code MAC2 calculated by the reader B according to the first session key k₀ of the sequence of session keys, and according to the identifier IDA of the controller A, and the identifier IDB of the reader B, and the security parameter PB generated by the reader B, and the security parameter PA generated by the controller A.
a step 1043 of verifying the first authentication code MAC1 received.

Symmetrically, and in correspondence with the steps of phase 104 of confirming the sequence of keys of the method 100 implemented by the reader B, the phase 204 of confirming the sequence of keys of the method 200 implemented by the controller A, comprises the following steps:
a step 2041 of emitting a first authentication code MAC1 calculated by the controller A according to the first session key k₀ of the sequence of session keys, and according to an identifier IDA of the controller A, and an identifier IDB of the reader B, and the security parameter PB generated by the reader B, and the security parameter PA generated by the controller A;
a step 2042 of receiving a second authentication code MAC2 calculated by the reader B according to the first session key k₀ of the sequence of session keys, and according to an identifier IDA of the controller A, and an identifier IDB of the reader B, and the security parameter PB generated by the reader B, and the security parameter PA generated by the controller A;
a step 2043 of verifying the second authentication code MAC2 received.

According to a particular example, the first authentication code is calculated according to a first predetermined alphanumeric value infoAB0, and the second authentication code is calculated according to a second predetermined alphanumeric value infoBA0.

More particularly, the security parameter PB generated by the reader B is another public key B_{EpubK} generated by the reader B, to which another private key B_{EprivK} generated by the reader B corresponds, and in which the secret S is concatenated with another shared secret S_{E} calculated from the other private key B_{EprivK} generated by the reader B and from the public key A_{SpubK} of the controller A, and the concatenated shared secret becoming the shared secret S used for step 1032 of calculating the sequence of session keys. Symmetrically, correspondingly, the security parameter PB generated by the reader B is another public key B_{EpubK} generated by the reader B, and in which the shared secret S is concatenated with another shared secret S_{E} calculated from the private key A_{SprivK} of the controller A and from the other public key B_{EpubK} generated by the reader B, the concatenated shared secret becoming the shared secret S used for step 2032 of calculating the sequence of session keys.

Even more particularly, the security parameter PA generated by the controller A is another public key A_{EpubK} generated by the controller A, to which another private key A_{EprivK} generated by the controller A corresponds, and in which the other secret shared S_{E} IS calculated from the other private key B_{EprivK} generated by the reader B and from the public key A_{EpubK} of the controller A. Symmetrically, correspondingly, the security parameter PA generated by the controller A is another public key A_{EpubK} generated by the controller A, to which another private key A_{EprivK} generated by the controller A corresponds, and in which the other shared secret S_{E} is calculated from the other private key A_{EprivK} generated by the controller A and from the other public key B_{EpubK} generated by the reader B.

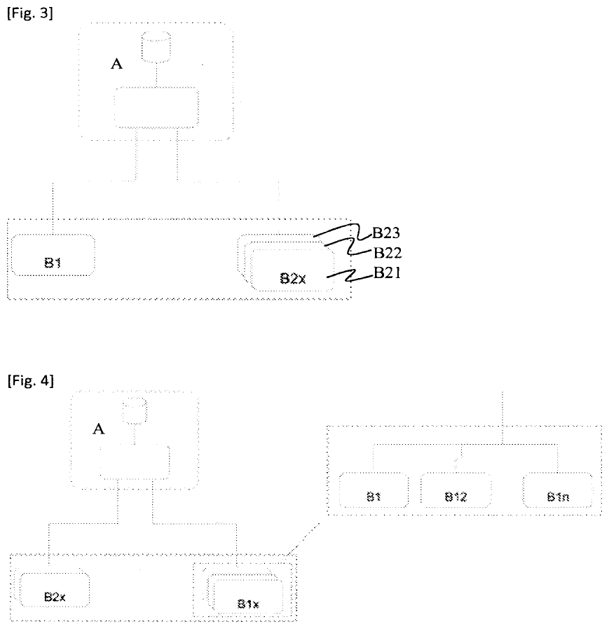

According to one example of implementation illustrated in FIG. 3, the controller A is configured to communicate with a plurality of readers B1, B21, B22, B23, a reader B1 among the plurality of readers being a master reader B1, the security mechanism being accepted by the master reader B1 during a phase of exchange of keys between the controller A and the master reader B1, the security mechanism accepted by the master reader then being the only one proposed to the other readers B21, B22, B23 of the plurality of readers B1, B21, B22, B23, during another phase of exchange of keys between the controller A with each of the other readers B21, B22, B23 of the plurality of readers B1, B21, B22, B23.

According to these provisions, the security between all readers is homogenized.

This particular mode also makes it possible to speed up the exchanges and reduce the quantity of data exchanged between the controller A and the other readers B2x, because there is no longer any negotiation possible, the controller only proposing a single option of encryption algorithm during the key exchange phase.

According to another example of implementation, illustrated in FIG. 4, the plurality of readers comprises a first group Bix of readers B1, B12, B1n configured to protect the access to a first area, and in which the plurality of readers comprises at least one second group B2x of readers B21, B22, B23 configured to protect the access to at least one second area, and in which the master reader B1 belongs to the first group of readers, the security mechanism being accepted by the master reader B1 during a phase of exchange of keys between the controller A and the master reader B1, the security mechanism accepted by the master reader then being the only one proposed to the other readers B12, B1n of the first group of readers B1, B12, B1n, during another phase of exchange of keys between the controller A with each of the other readers B12, Bin of the first group of readers B1, B12, Bin.

Thus, the homogenization may be applied locally, i.e. limited to the readers of a particular access control area corresponding to a group of specific readers Bix if the master reader belongs to this area, such as a security area with a high level of protection.

According to one aspect of the disclosure, the disclosure also concerns an access control reader B for controlling access to an area or an IOT hub, configured to communicate at least one information, read on a badge, to a controller A, according to one of the examples of implementation of the method 100 described above.

According to another aspect of the disclosure, the disclosure also concerns a controller A of an access control reader configured to communicate with the access control reader according to any of the examples of implementation of the method 200 described above.

1. A method for secure exchanges between a reader and a controller configured to communicate with each other via a communication channel, the method comprising the following phases implemented by the reader:
a phase of reading at least one information by the reader;
a phase of exchanging a public key (B_{SpubK}) of the reader and a public key (A_{SpubK}) of the controller;
a phase of generating a sequence of session keys;
a phase of confirming the sequence of keys based on the use of a first session key of the sequence of session keys,
a protocol phase for secure communication between the reader and the controller.

2. The method according to claim 1, wherein the key exchange phase is carried out during a phase of configuring the reader before a phase for on-site installation of the reader, via another communication channel between the reader and the controller, said other communication channel being different from the communication channel used on-site.

3. The method according to claim 1, wherein the information received, respectively emitted, during the key exchange phase is encapsulated in an IP frame.

4. The method claim 1, wherein the key exchange phase comprises:
a step of receiving the public key (A_{SpubK}) of the controller, and of receiving a list of security mechanisms (CcipherSuite) proposed by the controller, and of receiving a security parameter generated by the controller;
a step of emitting to the controller, the public key (B_{SpubK}) of the reader, and a serial number of the reader, and a security mechanism (Ccipher) accepted by the reader, said security mechanism (Ccipher) being chosen from among the list of security mechanisms (CcipherSuite), and a security parameter generated by the reader.

5. The method according to claim 4, wherein the public key of the controller is received in a certificate of the controller, and wherein the public key of the reader is emitted in a certificate of the reader.

6. The method according to claim 4, wherein the serial number of the reader is transformed or encrypted.

7. The method according to claim 4, wherein the phase of generating a sequence of session keys comprises the following steps:
a step of calculating a secret, shared by the reader and by the controller, the secret being calculated from a private key (B_{SprivK}) of the reader and from the public key (A_{SpubK}) of the controller;
a step of calculating the sequence of session keys from the shared secret, and from the serial number of the reader, and from the security parameter generated by the reader, and from the security parameter generated by the controller;

8. The method according to claim 7, wherein the step of calculating the sequence of session keys from the shared secret may be triggered by a fulfillment of a triggering condition among the following triggering conditions:
an idle time of the controller greater than a predetermined threshold;
a number of events greater than a predetermined threshold, the number of events being counted by a counter common to the reader and to the controller;
a command of the controller.

9. The method according to claim 4, wherein the phase of confirming the sequence of keys comprises:
a step of receiving a first authentication code calculated by the controller according to the first session key of the sequence of session keys, and according to an identifier of the controller, and an identifier of the reader, and the security parameter generated by the reader, and the security parameter generated by the controller;
a step of emitting a second authentication code calculated by the reader according to the first session key of the sequence of session keys, and according to the identifier of the controller, and the identifier of the reader, and the security parameter generated by the reader, and the security parameter generated by the controller;
a step of verifying the first authentication code received;

10. The method according to claim 1, wherein the protocol phase comprises a step of receiving by the reader a secure request coming from the controller, a step of calculating a signature from the at least one read information and a key of the sequence of session keys and a step of creating a frame comprising the signature concatenated with the read information and with an anti-replay counter, and a step of encrypting the frame by using another key of the sequence of session keys, and a step of transmitting the encrypted frame.

11. A method for secure communication between a reader and a controller configured to communicate with each other, the method comprising the following phases implemented by the controller:
a phase of exchanging a public key (B_{SpubK}) of the reader and a public key (A_{SpubK}) of the controller;
a phase of generating a sequence of session keys;
a phase of confirming the sequence of keys based on the use of a first session key of the sequence of session keys.
a protocol phase for secure communication between the reader and the controller.

12. The method according to claim 11, wherein the phase of exchanging a public key (B_{SpubK}) of the reader and a public key (A_{SpubK}) of the controller, comprises:
a step of emitting to the reader, the public key (A_{SpubK}) of the controller, and a list of security mechanisms (CcipherSuite) proposed by the controller, and a security parameter generated by the controller;
a step of receiving the public key (B_{SpubK}) of the reader, and a serial number of the reader, and a security mechanism (Ccipher) accepted by the reader, said security mechanism (Ccipher) being chosen from among the list (CcipherSuite), and a security parameter generated by the reader;

13. The method according to claim 11, wherein the phase of generating a sequence of session keys comprises the following steps:
a step of calculating a secret, shared by the reader and by the controller, the secret being calculated from a private key (A_{SprivK}) of the controller and from the public key (B_{SpubK}) of the reader;
a step of calculating the sequence of session keys from the shared secret, and from the serial number of the reader, and from the security parameter generated by the reader, and the security parameter generated by the controller;

14. The method according to claim 13, wherein the step of calculating the sequence of session keys from the shared secret may be triggered by a fulfillment of a triggering condition among the following triggering conditions:
an idle time of the controller greater than a predetermined threshold;
a number of events greater than a predetermined threshold, the number of events being counted by a counter common to the reader and to the controller;
a command of the controller.

15. The method according to claim 12, wherein the phase of confirming the sequence of keys comprises:
a step of emitting a first authentication code calculated by the controller according to the first session key of the sequence of session keys, and according to an identifier of the controller, and an identifier of the reader, and the security parameter generated by the reader, and the security parameter generated by the controller;
a step of receiving a second authentication code calculated by the reader according to the first session key of the sequence of session keys, and according to an identifier of the controller, and an identifier of the reader, and the security parameter generated by the reader, and the security parameter generated by the controller;
a step of verifying the second authentication code received.

16. The method according to claim 11, wherein the controller is configured to communicate with a plurality of readers, a reader among the plurality of readers being a master reader, the security mechanism being accepted by the master reader during a phase of exchange of keys between the controller and the master reader, the security mechanism accepted by the master reader then being the only one proposed to the other readers of the plurality of readers, during another phase of exchange of keys between the controller with each of the other readers of the plurality of readers.

17. The method according to claim 16, wherein the plurality of readers comprises a first group of readers configured to protect the access to a first area, and wherein the plurality of readers comprises at least one second group of readers configured to protect the access to at least one second area, and wherein the master reader belongs to the first group of readers, the security mechanism being accepted by the master reader during a phase of exchange of keys between the controller and the master reader, the security mechanism accepted by the master reader then being the only one proposed to the other readers of the first group of readers, during another phase of exchange of keys between the controller with each of the other readers of the first group of readers.

18. An access control reader for controlling access to an area or IOT hub, configured to communicate at least one information, read on a badge, to a controller, according to a method according to claim 1.

19. A controller of an access control reader or an IOT hub configured to communicate with the access control reader or an IOT hub according to a method according to claim 11.
